(19) United States
(12) Patent Application Publication
(10) Pub. No.: US 2004/0052412 A1
(43) Pub. Date: Mar. 18, 2004

(54) Satellite image enhancement and feature identification using information theory radial-basis bio-marker filter

(75) Inventors: Michael Wall, Vallejo, CA (US); Gershon M. Wolfe, Davis, CA (US); John S. Rakitan, Davis, CA (US)

Correspondence Address: Lucian Wayne Beavers, Waddey & Patterson, Bank of America Plaza, 414 Union Street, Suite 2020, Nashville, TN, 37219, US

(73) Assignee: LARGE SCALE BIOLOGY CORPORATION, Vacaville, CA

(21) Appl. No.: 10/434,556

(22) Filed: May 9, 2003

Related U.S. Application Data
(60) Provisional application No. 60/379,694, filed on May 10, 2002.
(60) Provisional application No. 60/385,776, filed on Jun. 4, 2002.

(51) Int. Cl. G06K 9/62; G06K 9/00

(52) U.S. Cl. 382/159; 382/128

(57) ABSTRACT

A computer implemented method analyzes and evaluates data and identifies disparate features. The data may be mass spectra, images of microarrays or images of 2D electrophoresis gels, where the data is based upon two patients or groups of patients, one healthy and the other having a disorder. The images may also be satellite images taken of a single region, the images compared to identify disparate features such as oil fires in Iraq during the 2003 Gulf War.

### PRIORITY DATA

The instant application claims priority to the following provisional applications: Serial No.: 60/379,694, filed May 10, 2002 and Serial No. 60/385,776, filed Jun. 4, 2002, both of which are incorporated herein by reference in their entirety.

### FIELD OF THE INVENTION

The invention relates to a computer implemented method for analyzing and categorizing sets of computer readable data. More specifically, the present invention relates to a computer implemented method for analyzing and categorizing predetermined sets of data into at least two subsets of categorized data, and further analyzing unknown data and determining which, if any, of the two subsets of categorized data the unknown data may belong. The present invention further relates to a computer implemented method for analyzing data sets that include data from a healthy set of patients and a disease afflicted set of patients, training a neural net to distinguish between the two sets of data, then use the neural net to distinguish data from patients being screened for that particular disease.

### BACKGROUND OF THE INVENTION

Bio-marker discovery has been thrust into the forefront of the state of the art in proteomics research and development. There are numerous methodologies and tools currently in use or being developed for identifying disease specific or condition specific bio-markers. A long practiced methodology for identification of bio-markers includes separation of proteins taken from tissue and/or bodily fluid samples using two dimensional electrophoresis gels, where after separation, the gels are stained, images made of the stained gel, the gel images analyzed, protein spots excised from the gel and submitted to further study using, for instance, mass spectrometry. Such methodology as set forth in, for instance, U.S. Pat. No. 5,993,627, to Anderson et al., includes computer software analysis of the gel images to locate proteins of interest, thereby making it easier to determine which protein spots represent potential bio-markers. However, even with the sophisticated computer software analysis, a high degree of human interaction is typically needed in order to make a determination regarding the uniqueness or importance of a particular protein spot that may appear on each gel, making the gel analysis process time consuming and expensive.

Recently, bio-chips or microarrays have been proposed as in, for instance, WO 01/09607, to Anderson et al., where a specially prepared array of bio-receptive spots captures bio-molecules, such as proteins, in order to identify and/or confirm bio-markers for use in research or diagnostic applications. The presence or lack of a captured bio-molecule on any of the numerous locations on the microarray must either be confirmed visually or with some kind of optical reading means, in order to determine the value and/or importance of the captured bio-molecule. Further, the visual or optical confirmation of capture must in turn be analyzed by a technician, physician or scientist, to determined the presence of the captured molecules. A rigorous method for quantifying and evaluating information from such microarrays is both desirable and necessary in order to take advantage of such scientific tools.

A recent publication by Petricoin et al. in The Lancet [4] describes a method where a proteomic pattern is discovered and used to classify patients with ovarian cancer. Based on the article's popularity and topic it may be a seminal piece of work. In the described method, mass spectrometry data from a group of healthy patients is compiled with mass spectrometry data from a group of ovarian cancer patients. Using a non-disclosed black box analysis, the two groups of data are analyzed and compared to identify patterns that represent protein markers that distinguish the diseased state from the healthy state.

Unfortunately, the authors neither disclose any features of their computational analysis, nor do they provide any defense of the computational method. As stated in the article, the authors use an undescribed method that employs a feature discovery component (a Kohonen feature map) with a genetic algorithm. The purpose of the genetic algorithm is to provide a means to qualify the classification ability of a specific proteomic pattern.

Pattern classification/categorization is a well established field with a known set of successful techniques [7]. The Lancet authors do not present any case of why it is necessary to employ a Kohonen feature map/genetic algorithm as opposed to simple methods such as spectral subtraction, principal component analysis, singular value decomposition, Bayesian Decision theory, Information theory and other statistical algorithms.

It is this absence of a defensible position that has fueled work on the present invention presented herein.

Information theory, also known as communication theory, dictates that data analysis and information transmission must take into account the information source, how the information is acquired, and the information to be extracted from the data. Without knowing the methodology employed by the authors of the Petricoin et al. referenced mentioned above, it is difficult to determine the value of the data manipulations that let to the conclusions described in the Petricoin et al. One of several objectives of the present application, is to use the teachings of information theory to devise a meaningful and reliable way of processing and interpreting the raw data obtained from the experiments described in Petricoin et al. The inventors have recognized that no one to date has analyzed and/or processed mass spec data, gel image data or microarray related data using radial basis functions (RBF).

The information theory radial basis function (RBF) originated as a radar signal processor whose purpose was to enhance cross-polarized radar signals emanating from cooperative signal-reflecting navigation buoys. The original research sought to address difficulties associated with ‘false-positives’ such as radar buoys located near naturally radar active objects (such as metal playgrounds, etc). Their solution was to enhance correlated features in two separate radar images (differing in their polarity) using information theory to discover these features.

Haykin et al, in ref [9] developed an optical processing system for use as an enhancement over existing radar navigation systems used to pilot riverboats. Their implementation includes an information theory radial-basis neural net whose purpose is to enhance spatial differences in corresponding regions in pairs of radar images. This type of analysis is very closely related to canonical correlation analysis in statistics where the goal is to correlate (or de-correlate) two signals by finding appropriate linear transformations that exhibit maximum (or minimum) mutual information.

Specifically, in riverboat navigation a surveillance radar system produces a pair of images from the environment of interest that includes a cooperative radar reflector. The environment is scanned and received using the same or different polarization, e.g. one can scan and receive using a horizontal polarization (horizontal-horizontal) or conversely scan horizontal and receive vertical (horizontal-vertical). A cooperative radar reflector associates the two images by rotating incident radar through 90 degrees. This cooperation can be uncovered and enhanced using mutual information. The resultant image produced by the optical processor exhibits significant improvement in cooperative target visibility.

The mass spectra data analyzed in Petricoin's work lacks the sophistication of the RBF radar analysis. The inventor of the present invention desires to improve upon Petricoin's work and has found advantageous ways of doing so using techniques based upon the RBF radar analysis techniques. Further, the inventor has found further applications of the present invention, as is described in greater detail hereinbelow.

### SUMMARY OF THE INVENTION

The present invention relates to a computer implemented method for analyzing and categorizing sets of computer readable data.

The present invention relates to a computer implemented method for analyzing and categorizing predetermined sets of data into at least two subsets of categorized data, and further analyzing unknown data and determining which, if any, of the two subsets of categorized data the unknown data may belong.

The present invention further relates to a computer implemented method for analyzing data sets that include data from a healthy set of patients and a disease afflicted set of patients, training a neural net to distinguish between the two sets of data, then use the neural net to distinguish data from patients being screened for that particular disease.

In accordance with another embodiment of the invention, the data analysis techniques described herein are used in pattern recognition applications, for instance, in the analysis of patterns on microarrays that have been exposed to a biological sample and have captured bio-molecules thereon, the captured bio-molecules being detectable and hence defining a pattern on the microarrays.

In accordance with another embodiment of the invention, the data analysis techniques described herein are used in pattern recognition applications, for instance, in the analysis images depicting patterns on stained 2D electrophoresis gels.

In accordance with yet another embodiment of the invention, satellite photographs of a specific region, where the photographs are taken at different times, are subjected to the data analysis techniques described herein to identify disparate features between the two photographs or array of photographs. The present invention is applicable to military surveillance operations where construction, equipment or troop movement is being observed.

The present invention includes a method for computer implemented identification of disparate features in at least two different images. The method includes providing or inputting at least two images to a computer, the two images showing the generally the same subject matter, but with possible differences therebetween. The two images are analyzed using a radial basis function such that background noise and features common to both images may be eliminated leaving only information relating to the differences between the two images. Hence, a new image is created by removing commonality between the two images. The disparate features remaining in the image created are then depicted.

It should be understood that in the above method, the images may be from any of a variety of sources. For instance, the images may include a first satellite image of a region and a second satellite image of the region taken at a later time interval, the first and second satellite images inputted into the computer for analysis and evaluation to determine disparate features.

Further, a plurality of additional satellite images of the region, each additional satellite image being taken at a different time interval, may be analyzed and evaluated by the computer method of the present invention.

Alternatively, the inputted images may be a first image of a microarray that has been subjected to a sample from a healthy patient and a second image of another microarray that has been subjected to a sample from a diseased patient, the first and second images being inputted into the computer for analysis and evaluation to determine disparate features, such as bio-markers.

Further, a plurality of images of microarrays, each additional image being taken of a microarray subjected to samples from different patients, may be inputted into the computer for analysis and evaluation.

Alternatively, the images inputted into the computer may be a first image of mass spectra from a sample from a healthy patient and a second image of mass spectra from a sample from a diseased patient. Further, a plurality of images of mass spectra, each additional image of mass spectra from a sample from different patients, healthy and diseased, may be analyzed and evaluated to determine disparate features, such as bio-markers, in accordance with the present invention.

The present invention also includes a method for automated computer identification of disorder markers from data, including a variety of steps or operations. First, a data set is compiled that includes at least two related data groups. Next, the data set is categorized based upon differences in the two related data groups. Commonality between the two related data groups is subtracted from both sets of data, thereby leaving only the differences between the at least two related data groups, identifying potential markers. These disparate features are then ranked to determine the most likely markers. For instance, if a disparate feature is clearly identifiable in most or all of the data from one group, but not from another group, then a potential marker has been identified.

Further, after compiling but before categorizing the data, quality control is performed on the data set. The quality control step can include normalizing the data set.

Further, after the quality control step but before the categorizing step features of the data set are enhanced.

The compiled data may include mass spectrometry spectra data.

The compiled data may alternatively include spot location data and spot intensity date (or images) of scanned electrophoresis gels.

If mass spectra data is being evaluated, the subtracting step includes subtracting spectral information from one of the two related data groups in the mass spectrometry spectra data.

The categorizing step includes use of a neural network for discriminating features in the data set.

The method for automated computer identification of disease markers of the present invention includes the use of radial basis functions for performing statistical differencing in the subtracting step.

The present invention also related to a computer apparatus that is trained to identify biomarkers where the biomarkers have been identified using the methods of the present invention. A sample from a possibly diseased patient is inputted into the computer apparatus and compared with previously identified disparate features from the source data sets to determine whether or not the sample from the possibly diseased patient includes the identified biomarkers.

### BRIEF DESCRIPTION OF THE DRAWINGS

FIG. 1A is block diagram showing an example of a computer system for implementing the data analysis and categorization methods in accordance with the present invention;

FIG. 1B is another block diagram showing another example of a computer system for implementing the data analysis and categorization methods in accordance with the present invention;

FIG. 2 is a flow chart showing operational steps of the data analysis and categorization methods in accordance with the present invention;

FIGS. 3A, 3B, 3C, 3D, 3E and 3F are diagrams provided to demonstrate various aspects of data processing and analysis in accordance with the present invention;

FIG. 4A is a plot that includes 4 graphs, each graph showing a portion of data processed in accordance with the present invention;

FIG. 4B is a data plot showing an example of a SELDI-MS data set analyzed and categorized in accordance with the present invention, and includes each of the four sub-sets of data depicted in FIG. 4A;

FIG. 5A is a chart showing network architecture of the analysis of a data set in accordance with the present invention;

FIG. 5B is a graph showing a projection of analyzed data in two dimensions;

FIG. 6 is a data plot showing the data shown in FIG. 4B after being analyzed, enhanced and processed in accordance with the present invention;

FIG. 7 is a data plot showing some of the bio-markers depicted in FIG. 6, the bio-markers having mass m/z values of 1223, 1440, 1519, 1972, and 2071, respectively;

FIG. 8 is a data plot showing a bio-marker at a m/z value of 5955;

FIG. 9 is a data plot showing a bio-marker at a m/z value of 4317;

FIG. 10A is a data plot showing a bio-marker at a m/z value of 3522;

FIG. 10B is a data plot showing the bio-marker depicted in FIG. 10A with all other peak information removed to further highlight the data at the m/z value of 3522;

FIG. 11A is a data plot showing a bio-marker at a m/z value of 4873;

FIG. 11B is a data plot showing the bio-marker depicted in FIG. 11A with all other peak information removed to further highlight the data at the m/z value of 4873;

FIG. 12A is a data plot showing a bio-marker at a m/z value of 10530;

FIG. 12B is a data plot showing the bio-marker depicted in FIG. 12A with all other peak information removed to further highlight the data at the m/z value of 10530;

FIGS. 13A and 13B are data plots showing before and after representations of colon cancer data derived from SELDI MS data, analyzed and evaluated in accordance with the present invention;

FIG. 14 is a chart showing bio-markers identified from a computer implemented analysis of the data depicted in FIG. 14B, in accordance with the methods of the present invention;

FIGS. 15A, 15B and 15C are flowcharts showing steps of operation of the methods of the present invention;

FIG. 16A is an image of a microarray having a pattern resulting from exposure to a sample from a healthy patient;

FIGS. 16B and 16C are images of microarrays having patterns resulting from exposure to samples from patients having the same affliction;

FIG. 16D is a microarray image output produced in accordance with the present invention showing false positive results based upon comparison of the microarray images depicted in FIGS. 16A, 16B and 16C;

FIG. 16E is a microarray image output produced in accordance with the present invention showing identified bio-markers resulting from an analysis and evaluation of the microarray images depicted in FIGS. 16A, 16B and 16C;

FIG. 17A is a satellite image of Iraq taken prior to the 2003 war;

FIG. 17B is a satellite image of Iraq taken during the 2003, with oil field fires burning;

FIG. 17C is an enhanced satellite image produced in accordance with the present invention showing the location of the oil field fires, the enhanced satellite image resulting from an analysis and evaluation of the satellite images depicted in FIGS. 17A and 17B;

FIG. 17D is an enhanced satellite image produced in accordance with the present invention showing lesser disparate features, such as clouds.

### DETAILED DESCRIPTION OF THE INVENTION

The present invention is a new analysis tool for analyzing and evaluating data where a comparison is to be made between a first set of data and a second set of data where a difference between the two sets of data is anticipated, but not confirmed. The invention includes a computer process whereby both sets of data are analyzed and compared to find differences therebetween. It should be understood that more than two data sets may be evaluated using the present invention.

Herein, we describe an algorithm that is capable of categorizing data sets, where the data sets may be selected from any one of a variety of types of data sets. An information theory radial-basis neural net (acronym BAMF) acting as an optical processor is employed to suppress noise and to enhance discriminating features present in a given data-set. A feed-forward neural net is then used to distinguish a diseased state from normal.

Examples of applicability of the methods of the present invention are provided hereinbelow, with several different types of data sets analyzed and evaluated, such as: an ensemble of SELDI MS spectra taken from serum samples of individuals afflicted with ovarian cancer [4-5], a set of 2D gels representing patients in various stages of colon cancer [6], microarray image data and satellite images.

For the data sets, discriminating patterns are computed and used to classify the training set. The ovarian cancer data set yielded discriminants of ˜25 peaks able to classify subsequent spectra with a 95% true positive accuracy and a 95% true negative accuracy. The prostate cancer data set yields similar results. Analysis of the satellite images clearly yielded identification of discriminating (or disparate) features, as is described in greater detail below.

The present invention includes a computer implemented method and apparatus for analyzing and categorizing sets of computer readable data. Specifically, the inventor has developed a computer implemented method and apparatus for analyzing a data set that includes two sub-sets of data, where the sub-sets of data have much in common, but have subtle differences. However, the data is inputted into the system as a single set of data, and the present invention distinguishes between the two sub-sets. For instance, in a first example, mass spectra from samples from a healthy group of patients and mass spectra from a disease-afflicted group of patients are analyzed and evaluated. The computer implemented method categorized the data set into subsets, distinguished the healthy patient data from the afflicted patient data, trained a neural net to analyze new data and determined which of the two sub-sets of data the new data belongs thereby providing a means for distinguishing healthy patients from afflicted patients with respect to the particular disease corresponding to the set of data.

The inventor has constructed new computer algorithms and corresponding processing steps in order to analyze the data set, categorize the data set into two sub-sets of data that can be distinguished from one another, identify characteristics or markers that distinguish the two data sets from one another, and provide a neural net that can be used thereafter to analyze new data of similar origins to determine which of the two data sets the new data belongs. The methods and computer system of the present invention are applicable to the study of disease states verses healthy states providing a quick and reliable way of distinguishing between a health state and an afflicted state for a predetermined disease condition or conditions, as is described in greater detail below. The present invention is also applied to numerous types of data, such as image data.

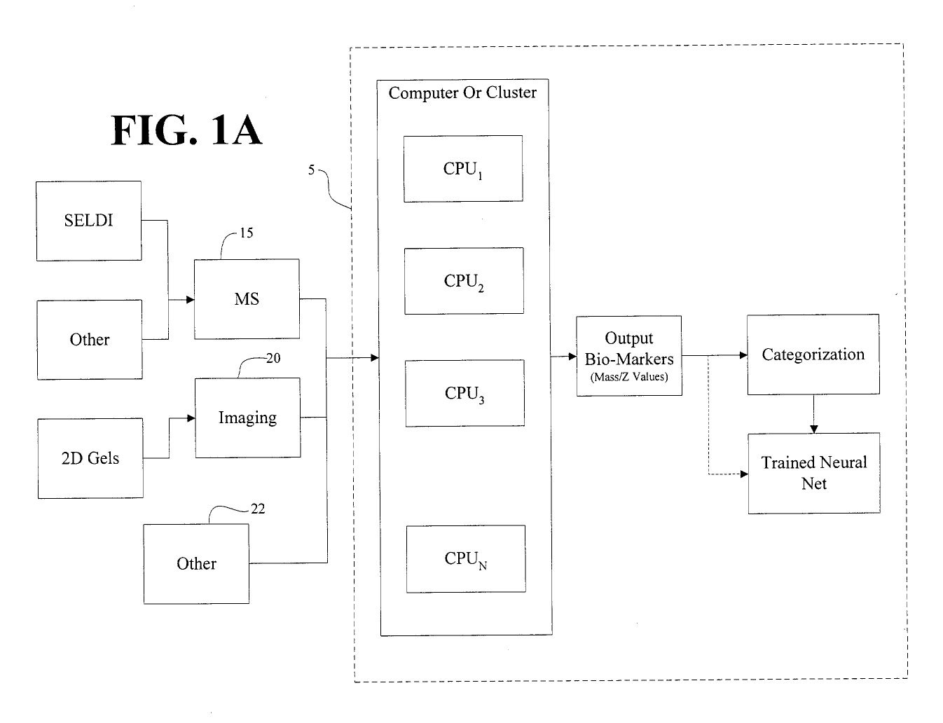

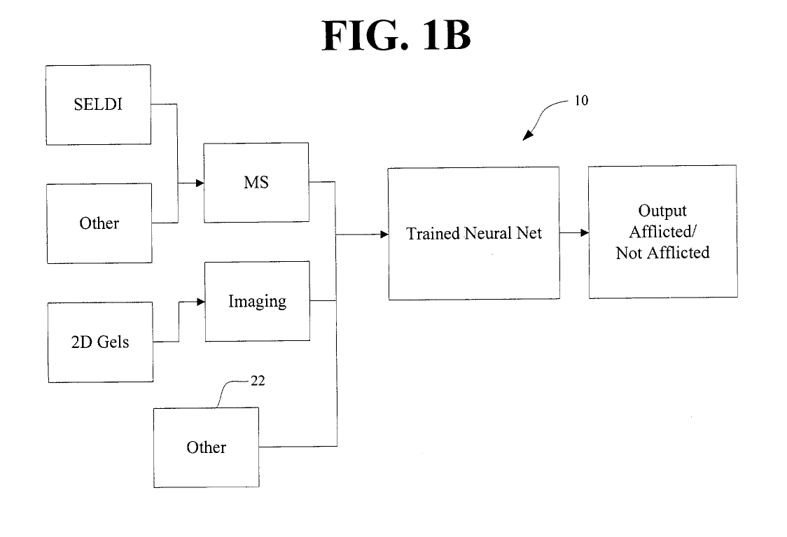

The present invention is implemented on a computer or array of computers in a computer system, such as the computer system 5 depicted in FIG. 1A. The computer system 5 may be a single computer or may be a cluster of computers with processors CPU₁, CPU₂, CPU₃ through CPU_{N}, that effect parallel processing where independent computations take place in parallel. Such clustering of such computer processors to effect parallel processing is well known in the computer arts for increasing computational power, but is applied herein in a new and novel way in order to practice the methodology of the present invention. The clustered processors provides a significant amount of computational power that is necessary in a training phase, as described below, where significant amounts of data, such as mass spectra data, are analyzed and categorized, as is described herein below, to create a neural net processing capability that is able to analyze new data and determine whether or not that new data indicates a possible disorder in a patient or a healthy state in a patient.

It should be understood that once a trained neural net is established, a smaller computer system, such as the computer system 10 depicted in FIG. 1B, may be programmed to analyze unknown data and determined whether the unknown data came from a healthy patient or an afflicted patient with respect to a specific disease state or states.

Returning to FIG. 1A, the computer system 5 is provided with any of a variety of data sources. In one embodiment of the present invention, the computer system 5 is provided with data from a mass spectrometer 15. In another embodiment, the computer system 5 is provided with data sets from an imager 20 that creates and transmits images of 2D electrophoresis gels. It should be understood that the present invention is such that the data set provided may be any type of data having a plurality of data points, as is described in greater detail below. For instance, the present invention can process mass spectral data and use such data to categorize, identify markers and establish a neural net to distinguish between a disease state and a healthy state. Alternatively, the present invention can process images of 2D gel to categorize, identify markers and establish a neural net to distinguish between a disease state and a healthy state. Alternatively, the present invention can process other types of data to categorize, identify markers and distinguish between a first state and a second state.

In order to provide a robust data analysis and evaluation system, the computers 5 and/or 10 are programmed to receive any of a variety of data, thus avoiding costly re-coding of BAMF at every instance where the data format changes. Specifically, a limited amount of data polymorphism is included in BAMF, such that BAMF accepts sets of vectors (vector ensembles) where the vector elements are tuple-types. In this fashion, data can be presented to BAMF as simple as 1D mass spectra or as 2D Gel images. In the case of 2D gels, our spectra is a 2D gel image quantized as a spot intensity located at a specific (x, y) coordinate. All data vectors in the ensemble are intensities sampled at the same (x, y) coordinates. This limited polymorphism extends BAMF's reach to all vector ensembles that are inherently vectors of tuples. Photographs, microarray images and satellite images are inputted in a similar manner. For instance, images, such as photographs or scanned 2D electrophoresis gel images, are inputted in PGM (portable gray map) format.

The data sets analyzed and categorized in the practice of the present invention preferably include ensembles of vectors that are in the form of n-vectors of m-tuples such as:

n-vectors={v₁, v₂, v₃. . . . } where

$$\begin{matrix}{v}_{1} = {[ \begin{matrix}{x}_{1} \\ {x}_{2} \\ {x}_{3} \\ \cdot \\ {x}_{n}\end{matrix} ]}^{m = 1} \\ or \\ {v}_{1} = {[ \begin{matrix}{x}_{1} , & {y}_{1} \\ {x}_{2} , & {y}_{2} \\ {x}_{3} , & {y}_{3} \\ \cdot & \cdot \\ {x}_{n} & {y}_{n}\end{matrix} ]}^{m = 2} \\ or \\ {v}_{1} = {[ \begin{matrix}{x}_{1} , & {y}_{1} , & {z}_{1} \\ {x}_{2} , & {y}_{2} , & {z}_{2} \\ \cdot & \cdot & \cdot \\ {x}_{3} , & {y}_{3} , & {z}_{3} \\ {x}_{n} , & {y}_{n} , & {z}_{n}\end{matrix} ]}^{m = 3}\end{matrix}$$

etc., where m may be equal to values of 8, 9, 10 or larger.

Examples of such data with n-vectors of m-tuples are mass spectra that is typically a set of data where m=1. For 2D gel images, microarray images, the data will be such that m=2. Other image data may be such that m=3, 4 or 5 and higher.

Regardless of the type of data (i.e., the value of m), the data is processed, analyzed and categorized in generally the same manner, as described below.

Here BAMF implements a similar information theory radial basis function (RBF), differing primarily in application specific areas unimportant to correlated feature discovery.

A computer algorithm and accompanying computer program(s) have been developed by the inventor for bio-marker discovery using information theory, for processing, analyzing and categorizing the above described data utilizing, in part, well established methods used to remove noise and enhance cooperative targets present in radar images [1-3]. The inventors have implemented a very basic feed-forward neural net that uses outstanding features to discriminate the normal from the diseased states.

By the methods of the present invention which include the use of a mutual information theory radial-basis bio-marker filter (BAMF), the inventor has developed new bio-markers for ovarian cancer present in the data set used in the original Lancet article by Petricoin el al., as is described in greater detail hereinbelow. Further, the inventor has also identified new bio-markers from a similar data set taken from individuals afflicted with prostate cancer using the BAMF technology of the present invention.

Ovarian cancer bio-markers were identified from mass spectral data using the BAMF technology, and colon cancer bio-markers were identified from a 2D gel data-set generated from patients in various stages of colon cancer using the BAMF technology of the present invention, as is described in greater detail below.

For each implementation of the present invention on a computer system, such as that depicted in FIG. 1, the data is supplied from a specific data source. The data sets analyzed in accordance with the present invention must be consistent.

Algorithm Overview

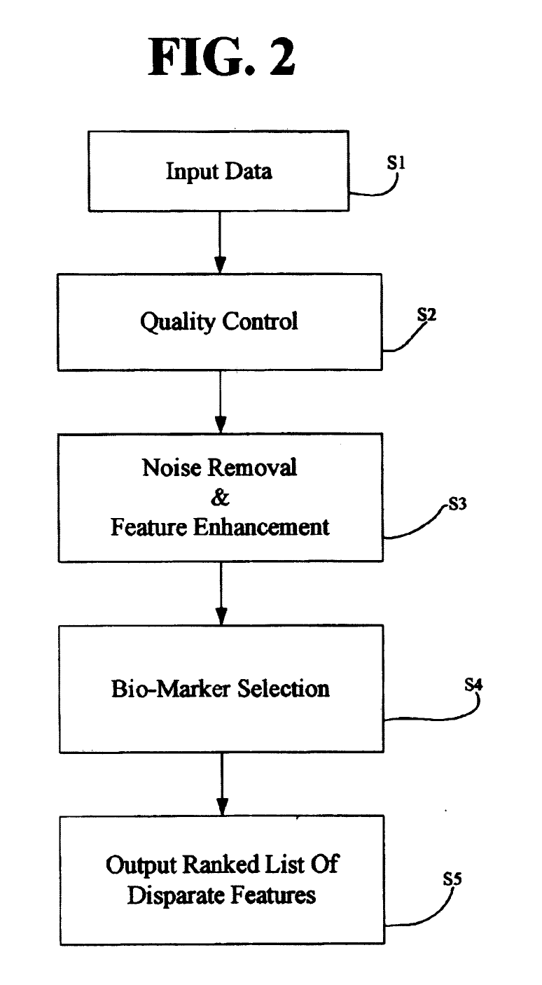

A basic flow chart of BAMF methodology is provided in FIG. 2. The data set is first inputted into the computer system 5, as indicated at step S1. In the first stage, as indicated at step S2, quality control (QC) is performed. where the data-set is normalized against some reasonable metric and outliers are rejected. A region of interest is chosen and the original data-set is aligned and interpolated onto a uniform grid. At present interpolation is done either linearly or using the Fast-Fourier transformation.

In a second stage, indicated at step S3, RBF feature enhancement and noise suppression are conducted on the data set. Specifically, an information theory radial-basis neural net is employed as an optical processor that suppress noise and enhances discriminating features. The architecture is similar in spirit to networks employed in the radar related references [1-3].

In a third stage, indicated at step S4, in FIG. 2, the data set is subjected to quantification of disparate features. Specifically, the results of the second stage are used to find features unique to each data set. A bio-marker “model” is then built using a basic window/threshold criteria (see Appendix). The output of this stage is a vector of m/z values for which intensities can be selected from incoming spectra.

In a fourth stage, indicated at step S5 in FIG. 2, the processed data is further processed by categorization of spectra using a feed-forward neural net. In this final stage, an associative neural net is trained to associate truncated spectra with radii in a 2-dimensional discriminant space. This stage can be iteratively operated to refine the model produced in stage three.

The above mentioned stages, depicted in FIG. 2 are described in greater detail below.

Data Matrix

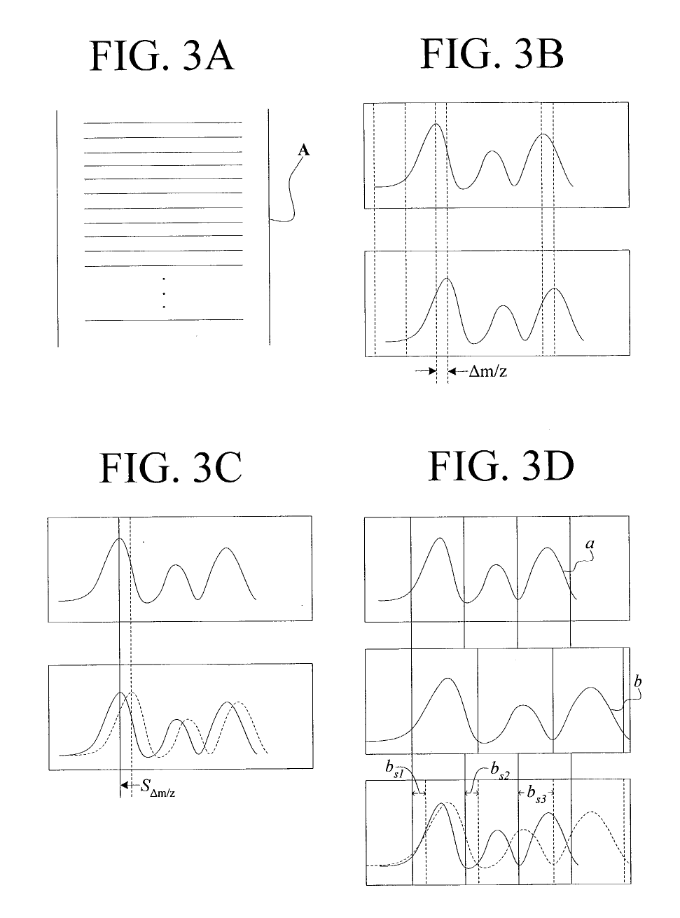

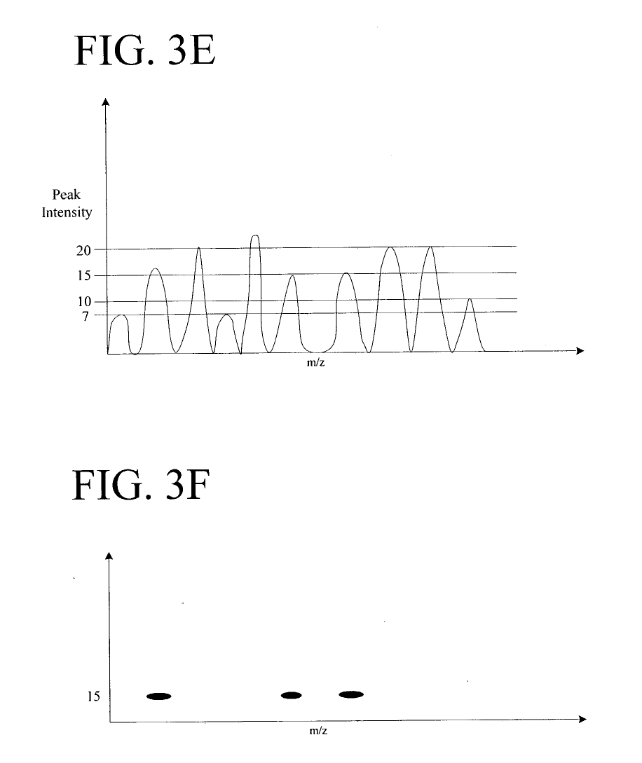

At its highest level of abstraction the inventor adheres to programming protocols, that include convenient restrictions where the rows of the data matrix A depicted generically in FIG. 3A represent specific regions of m/z (mass over charge) data and columns correspond to specific patients. More specifically, the data matrix A includes spectra corresponding to the above described n-vectors of m-tuples of the data set.

In the case where the data set originates from a mass spectrometer, such as a SELDI-MS device, the data matrix A is arranged as follows: each column of A is a unique spectra corresponding to a sample from a single patient that has been subjected to mass spec analysis. Each row of A corresponds to a unique value of m/z after the QC step S2 shown in FIG. 2. FIG. 3A shows a simplified visual representation of A.

In the case where the data set originates from images of two dimensional electrophoresis gels, a row in the data matrix A corresponds to a spot; the same spot as identified across all gels in the ensemble and each column represents a unique patient.

In the discussion that follows it is necessary to use a specific column(s) or row(s) as an example of the analysis and processing of the entire data set. For instance, statistical functions are usually performed for a specific region (m/z); specifying a row of the data matrix. We will refer to either a row or column of A using a single index whose identity is context-evident. In the case where the raw data is an image, the data matrix is the image itself, with pixel location and pixel intensity being the matrix A.

Data Sets

The National Cancer Institute has made available to the public their ovarian cancer data set which was derived from samples examined using SELDI-MS (mass spectrometer spectral data). The colon cancer data sets were provided by Large Scale Biology Corporation from their Germantown Md. proteomics research facility and is in the form of images of two dimension electrophoresis gels. Although both types of data were analyzed, in order to simplify description of the algorithm of the present invention, the description that follows is primarily directed to the example where mass spectra is analyzed, categorized and bio-markers identified.

Quality Control

In the quality control step (step S2 in FIG. 2), each spectra is subjected to the following standard procedures:

Region selection and interpolation. Under several scenarios it is often more efficient to concentrate on only a certain region of the data, such as a portion of each spectra in the mass spectrometer data set. For mass spectra, an equi-spaced dense grid is laid out at a specified resolution of ½ AMU and the original data-set is linearly interpolated onto this grid.

Normalization. In the even of grossly un-uniform data we have developed an optional normalization scheme. Normalization reduces the detection of false-positives.

Under most circumstances we have employed simple Euclidean normalization and constant transformation. In either case it is necessary not to destroy an expression level bio-marker, as such normalization is done within a category or by scaling to some constant derived from the entire data-set. For the data matrix A the normalization condition is,

$${\sum }_{i} {A}_{ji}^{2} = κ$$

where κ is an appropriately constrained constant (eg κ=1.0).

Alignment. In the event of systemic spectral drift, we employ a simple alignment algorithm. Introducing the shift operator Ŝ_{dx} which shifts a column vector by the differential amount χ, and for an arbitrarily chosen canonical column vector at index α we maximize the dot-product,

\vec{Aₐ}·(\hat{\vec{S}}_{dx}Aᵢ)

to determine that value of x for which column vector Aᵢ should be shifted such that it nominally aligns with the canonical reference A_{α}. This procedure will not correct any intra-peak stretches or compressions.

For example, in the normalization of data, corresponding portion, as shown in FIG. 3B, two separate mass spectra data may not be aligned perfectly, i.e., the data may be linearly offset due to instrument inconsistencies. Therefore, it is necessary to interpolate many of the spectral vectors, as shown in FIGS. 3B and 3C where a linear offset Δm/z is determined for each individual spectra, and is used to generate an operator S_{Δm/z} to shift the offset individual spectra into alignment with all other spectra in the data set A. It should be understood from the above that the vector set Ŝ_{dx}, has as its domain m/z.

In the event that non-equi-spaced data is included in the data set, it is also necessary to employ more sophisticated methods such as interpolation by Fast-Fourier transformation in order to bring such data into alignment with other spectra in the data set. Further, the spectral shifting described above demonstrated in FIGS. 3B and 3c is also applicable incrementally on a spectra such as the spectra a and spectra b depicted in FIG. 3D. Specifically, the spectra a and spectra b are offset from one another and are also stretched, peak to peak, demonstrating non-linear instrumentation inconsistencies. Therefore, the peaks in spectra b will not align with spectra a using a linear shift, but rather must be proportionally manipulated by a series of operators bₛ₁, bₛ₂, through b_{sN}. In such cases, the mass spectral data is divided into predetermined segements, which in the preferred embodiment is 500 amu, thereby allowing the individual peaks of a spectra b to be segmented, and linearly offset to align with similar peaks in the spectra a, by calculated operators bₛ₁, bₛ₂, through b_{sN}, as shown in the lower section of FIG. 3D.

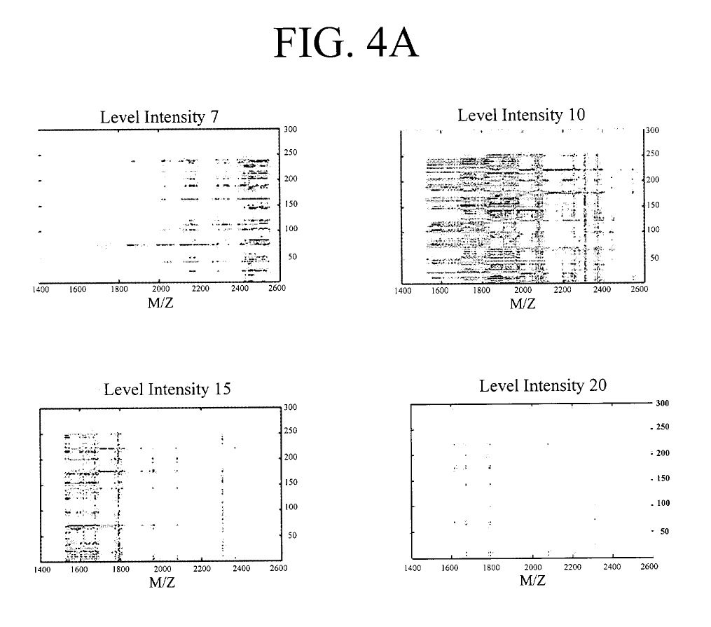

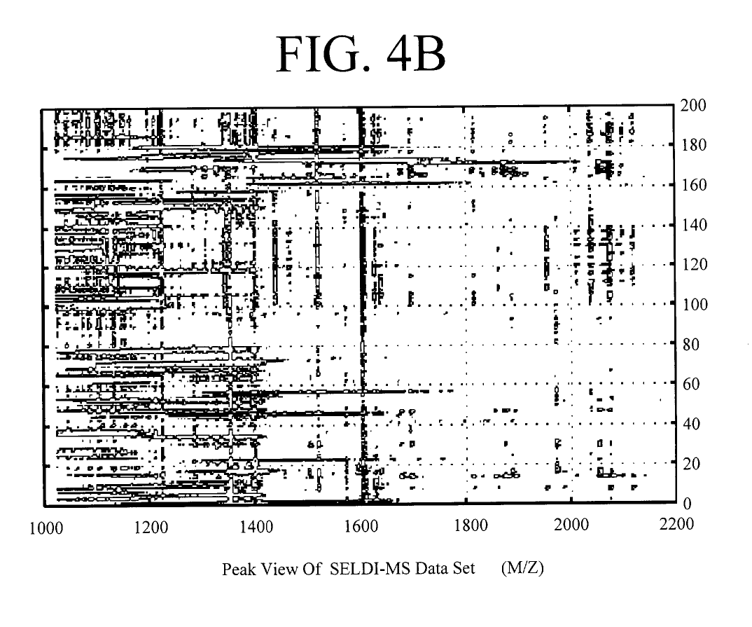

After quality control of the ovarian cancer data mentioned above, a simple plot is generated, as depicted in FIG. 4B, where the abscissa is m/z and the ordinate is an index corresponding to a mass spectra, and each horizontal line in FIG. 4B represents data from a unique patient. The plot of data depicted in FIG. 4B is multi-layered, and on a computer monitor includes shading, various colors and various intensity of those colors. In order to emphasis the level of detail provided by the data depicted in FIG. 4B, FIGS. 3E, 3F and 4A are provided to better understand the plotted data. Specifically, FIG. 3E is an example mass spectra showing the peak intensities of the mass spectrometer output. FIG. 3F shows dots that represent only those peak intensities corresponding to level 15, on the arbitrary scale depicted in FIG. 3E.

Specifically, in FIG. 3F, the peak intensities at level 15 are isolated from other peaks and are shown linearly in FIG. 3F as a quazi-topographical map where only peaks of intensity 15 are shown. In other words, FIG. 3F is a top view looking down at the peak intensities 15 of FIG. 3E. Therefore, in FIG. 3F, we only see the peaks at level 15 of the graph shown in FIG. 3E. Similarly, in FIG. 4A, a plurality of ovarian cancer mass spectra are analyzed in accordance with the present invention, and the peak intensities of about 7, 10, 15 and 20 are also each isolated and shown in separate graphs. In FIG. 3F only one set of peaks of a single mass spectra is depicted. In FIG. 4A several hundred mass spectra are shown, each of the four graphs corresponding to a different isolated level of the group of mass spectra.

FIG. 4B includes all of the data depicted in FIG. 4A, but with the data layered, one peak intensity level layered on top of the lower layers. The data in FIG. 4B is further divided into two portions, where data between 1-100 represents patients with ovarian cancer and the data between 101-200 represent patients without ovarian cancer. It is the peak intensities that are of interest and are analyzed and evaluated by the methods and apparatus of the present invention.

Feature Enhancement Using an Information Theory Radial Basis Neural Net

The data depicted in FIG. 4B is further analyzed and processed in accordance with the present invention. Specifically, to remove noise and enhance features, an information theory radial basis neural net is constructed by the computer system 5, processing the two portions of the data by treating them as separate images. In accordance with present invention, noise is removed and cooperative features present in both images enhanced. In the present invention, one image is the spectra from patients without a diseased state and the other image is spectra from patients with the disease state.

The methods of the present invention are used to detect of bio-markers. Our image is a bird's eye view of the data matrix A, shown in FIG. 4B, segregated into two groups, normal N and cancer C, and is the SELDI MS data set provided by Petricoin et al.

A further description of the data shown in FIG. 4B, based upon the work of Petricon is available in the references [1-3], which are incorporated herein by reference in their entirety.

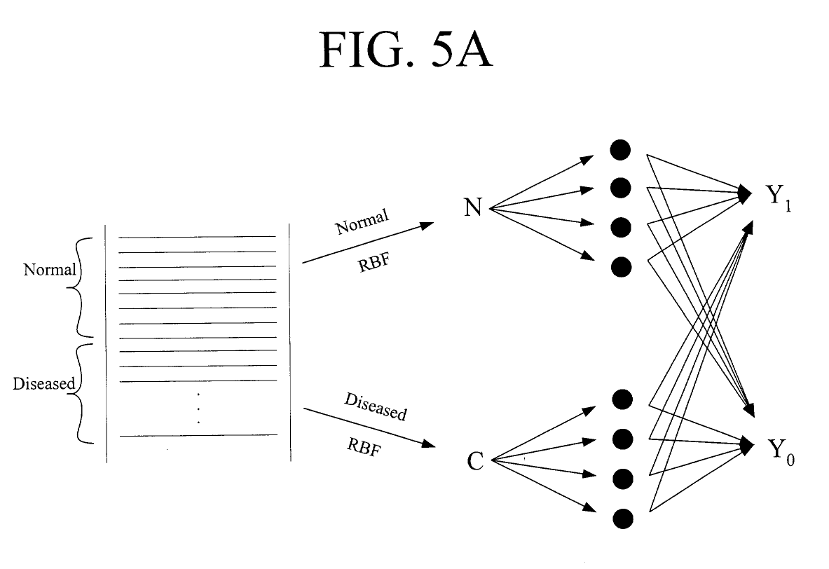

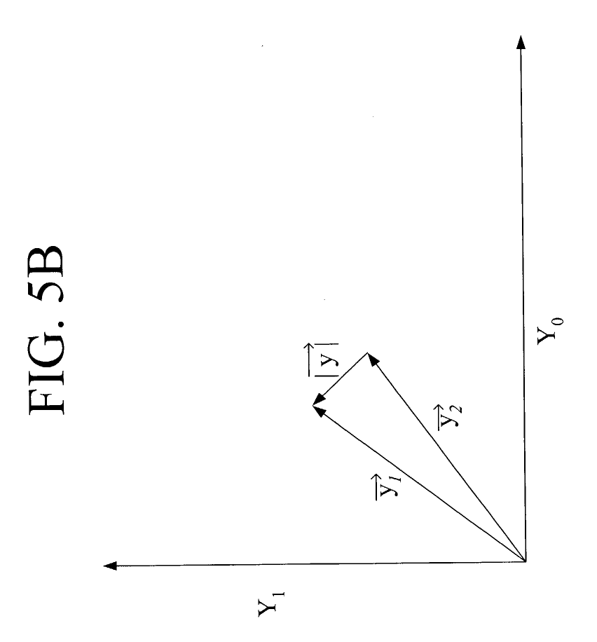

FIG. 5 shows the architecture of a radial basis function (RBF) network that is created by the computer system 5 in accordance with the present invention. Two optical modules operate on regions of similarity (a unique m/z or spot index) by first expanding the input data onto the RBF basis functions. In other words, the raw data depicted in FIG. 4B and represented in FIG. 5 on the left side by parallel horizontal lines, is processed by two optical modules and projected into two dimensional space, as indicated at the right side of FIG. 5. In the presence of any intra-spectra relations (e.g. a time-progression study over the course of the cancer) the input vector would be a row vector of the data matrix, Nᵢ and Cᵢ (normal state N and cancer state C or diseased state), where i specifies a specific m/z. In the absence of any reasonable ordering among the individual experiments, the spectral vectors deprecate to scalars (such as the row average,

Nᵢ→<N>ᵢ.

Expansion onto the Gaussian layer is given by,

Sᵢ=e^{-(∥Nj-δi∥)}^{²}^{/2/σi}^{²}

with δᵢ and σᵢ being the basis centers and widths respectively.

Centers are chosen as the row vectors of A. The widths σ are chosen as either a representative standard deviation of the entire A matrix or as the standard deviation of the row vector Aᵢ. In the event of incomplete data it is necessary to choose centers and widths in some optimized sense. It is worth noting here that the Expectation maximization, maximum likelihood algorithm [7] can reliably deliver statistically optimized centers and widths.

Final transformation onto the output layer (discriminant space) is given by,

\vec{y}=W·\vec{S}

with W being the weight matrix (it is necessary to constrain W in order to conserve entropy; more below). Features are enhanced by minimizing the mutual information of the components of the 2D output vector \vec{y} (also (y1; y2)). Under the assumption that the components of \vec{y} behave like a Gaussian random variable it is straightforward to show [1] that the mutual information I(y1; y2) is given by

I(y1; y2)=−log (1−ρ²_{y})/2

where y of the term (ρ²_{y}) is the vector \vec{y}, and ρ_{y} is the correlation coefficient between the components of \vec{y}. Minimization of I(y1; y2) directly implies minimization of ρ_{y}.

Constrained minimization of I(y1; y2) is done using Newton's method taking care to minimize along the weight surface that conserves entropy, i.e., we impose the constraint tr[W^{T}·W]=1.

Feature Enhancement.

Upon minimization of I(y1; y2) a feature mask is developed in y (discriminant space) and used to transform A.

To better understand the above described operation, FIG. 5B depicts an example of the data evaluation process. Each (Y₀, Y₁) depicted at the right side of FIG. 5A is plotted in discriminant space, as shown in FIG. 5B. Specifically, for a single m/z value, all points (Y₀, Y₁) are plotted. If for that m/z value, the absolute value |\vec{y}| is large or fluctuates wildly, the that m/z value may represent a bio-marker or has some meaning, and is not merely noise. If absolute value |\vec{y}| is very small or is zero, then that m/z value is either noise or may be irrelevant. The computational representation of this process is referred to as a diagonal feature transformation matrix F takes as its elements

Fⱼⱼ=∥yⱼ−yⱼ⁰∥

where yⱼ⁰ represents the discriminant vector prior to minimization.

The data matrix A is then transformed by removing all m/z values that have a |\vec{y}| value that is zero or very low, thereby producing a final, feature enhanced data matrix [symbol] , given by

[symbol]

=F·A.

where the matrix F enables spectral cleanup of the matrix A thereby generating the cleaned, enhanced matrix [symbol] , that is depicted in the bird's eye view in FIG. 6. FIGS. 4B and 6 show the same data, where FIG. 4B shows the original aligned data matrix A and the enhanced data matrix [symbol] is shown in FIG. 6. It should be understood that other feature masks can be developed from discriminate space for accomplishing image clean-up, feature separation and/or noise removal.

Categorization With a Feed-Forward Neural Net

Bio-markers are recovered by scanning overlapping regions of m/z and combining their respective difference maps. Specifically we take the simple spectral difference, d,

dⱼ=<\check{N}>ⱼ−<\check{C}>ⱼ

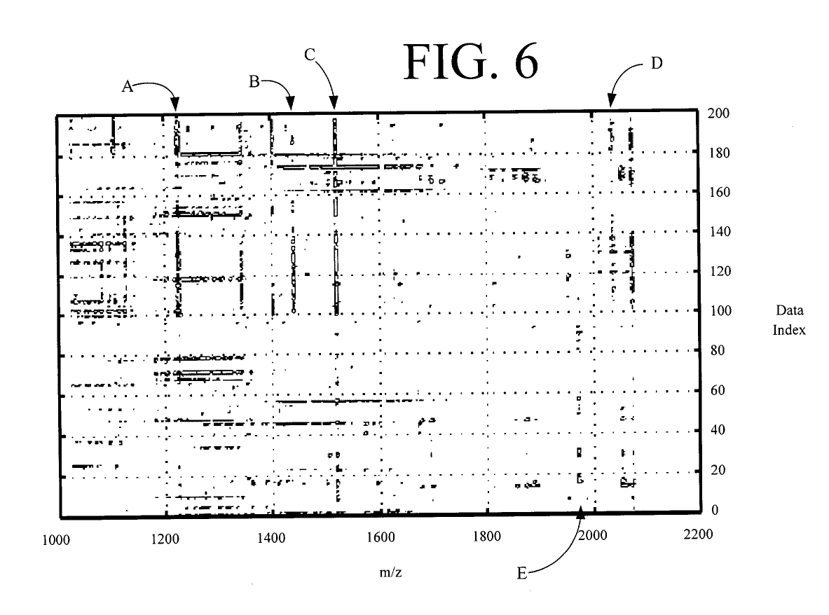

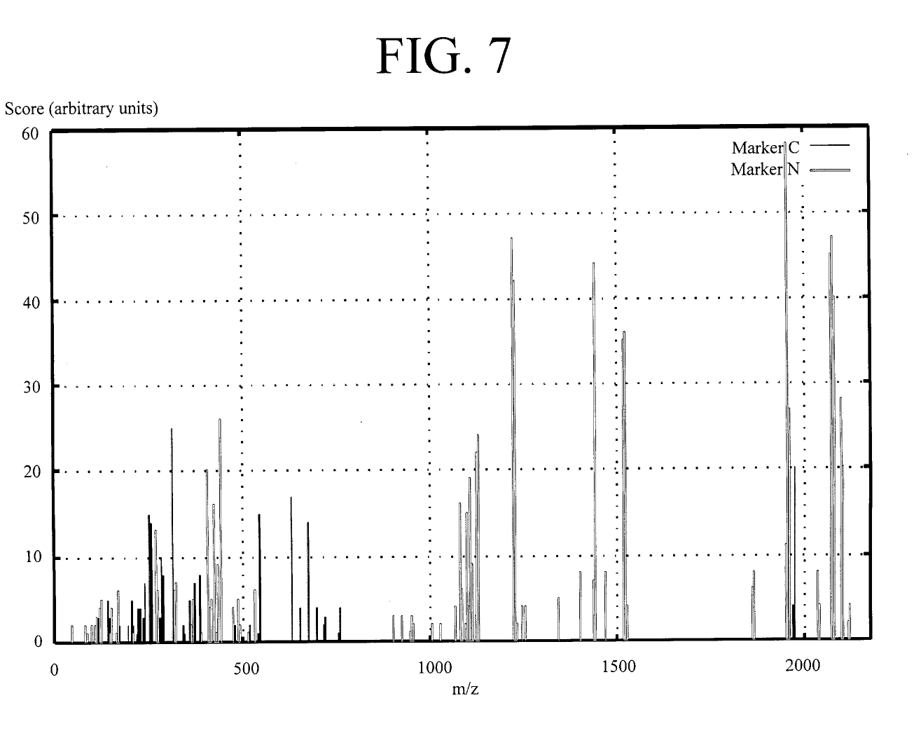

and track the locations of its extreme values. A scoring profile is presented in FIG. 7, where the peaks depicted are actually the values |\vec{y}| for each of the m/z values of interest. From this profile, an initial set of features is chosen using a straightforward “model-builder” (see Appendix).

A 3-layer feed-forward neural net is trained on this data set to distinguish cancer spectra from normal. Specifically, during training phase incoming spectra are sampled at the m/z locations of the bio-markers in the model and this truncated vector is imposed onto the input layer of the neural net. The neural net is trained to perform association where normal spectra and diseased spectra are matched to radii on the 2-dimensional output layer.

Quantification of the neural net is done using spectra not present in the training set. Practice training is performed on the even members of the data set, quantification is done using the odd members.

It should be understood that categorization may alternatively be done using other methods, such as Kohonen self organizing maps or K-means clustering.

Ovarian Cancer Results

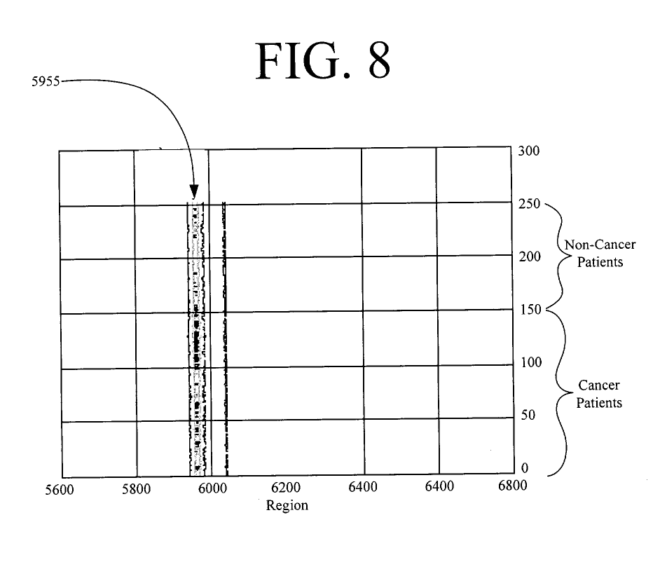

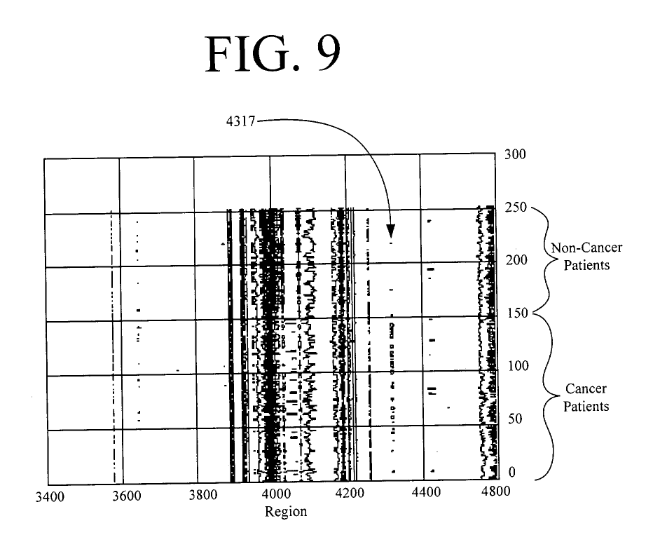

The ovarian cancer data from Petricoin et al., was evaluated using the present invention, and the following markers were identified. Specifically, as indicated in FIG. 6, bio-markers A, B, C, D and E were identified at m/z values 1223, 1440, 1519, 1972, and 2071, respectively. Peaks at these m/z values are also depicted in FIG. 7. Another portion of the analyzed mass spectra is plotted in FIG. 8, where a bio-marker is identified at an m/z value of 5933. In FIG. 9, a marker is shown at an m/z value of 4317.

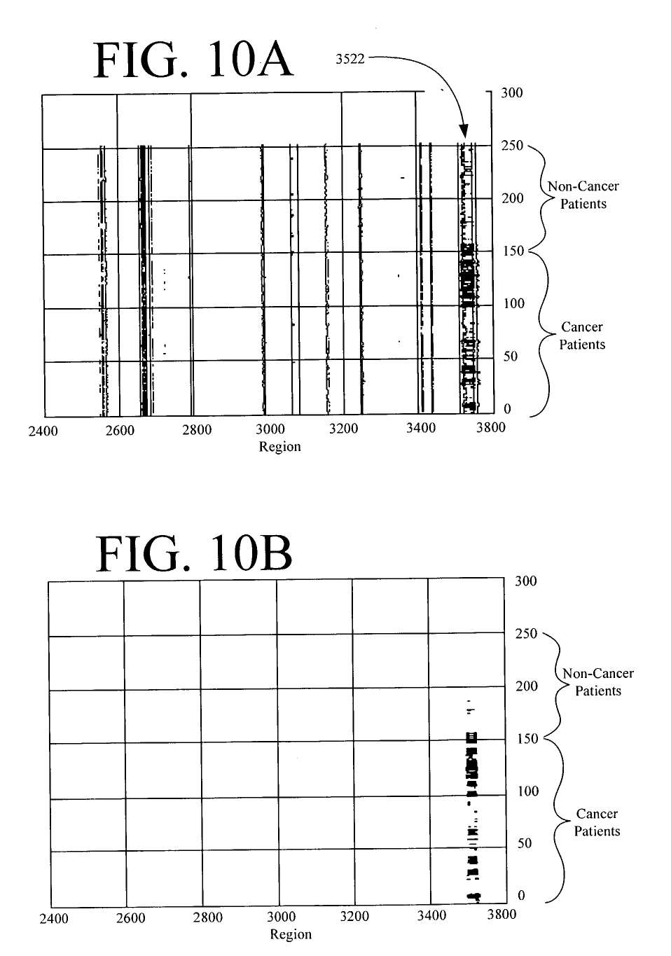

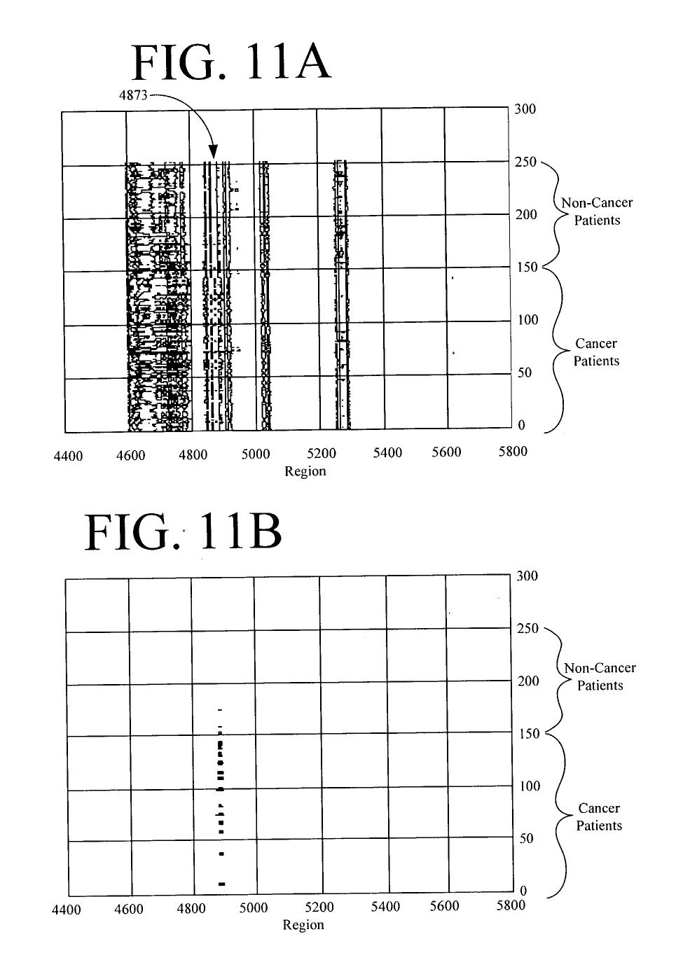

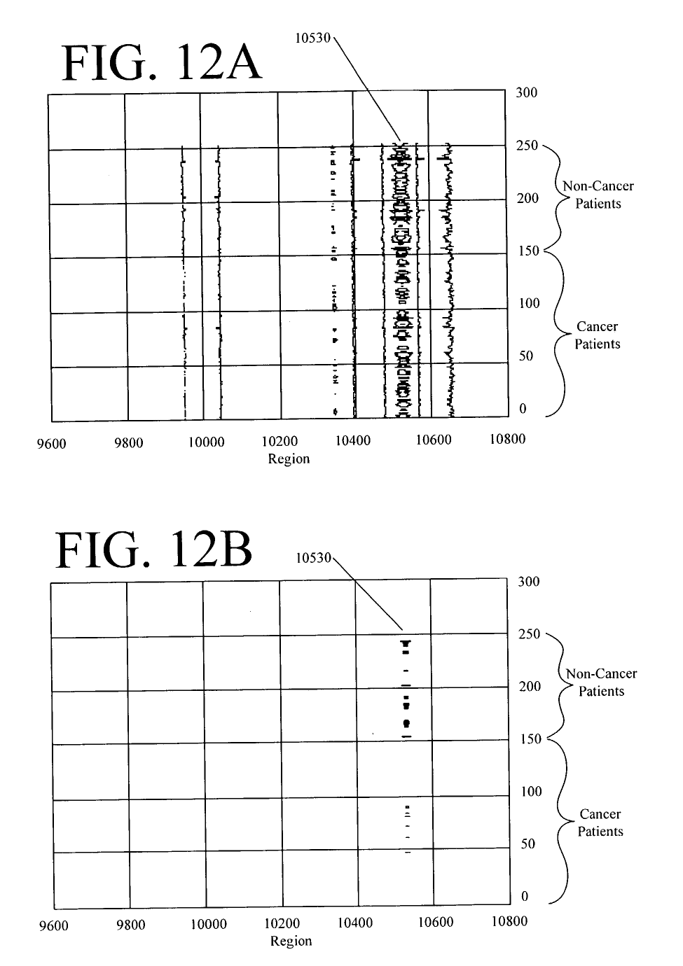

A bio-marker was identified at m/z=3522, as indicated in FIG. 10A. However, the marker is difficult to see because the original data was plotted with colors representing differing peak values. Since the color cannot be shown adequately in a black ink rendering, all other peak values have been removed in the depiction provided in FIG. 10B, where the 3522 m/z peaks are clearly visible. Similarly, BAMF identified another marker at an m/z value of 4873, as shown in FIG. 11A. All other peak values were removed from the depiction in FIG. 11B, clearly showing the m/z values of 4873. Again, in FIG. 12A, the present invention identified another bio-marker at an m/z value of 10530. In FIG. 12B, all peak values except 10530 have been removed to more clearly show the identified bio-marker.

The bio-markers at m/z values 1223, 1440, 1519, 1972, 2071, 3522, 4317, 4873, 5933, and 10530 respectively, all derived from the data provided by Petricoin et al., provide clear indications of differences between diseased and healthy patients that were not identified by Petricoin et al.

Colon Cancer Results

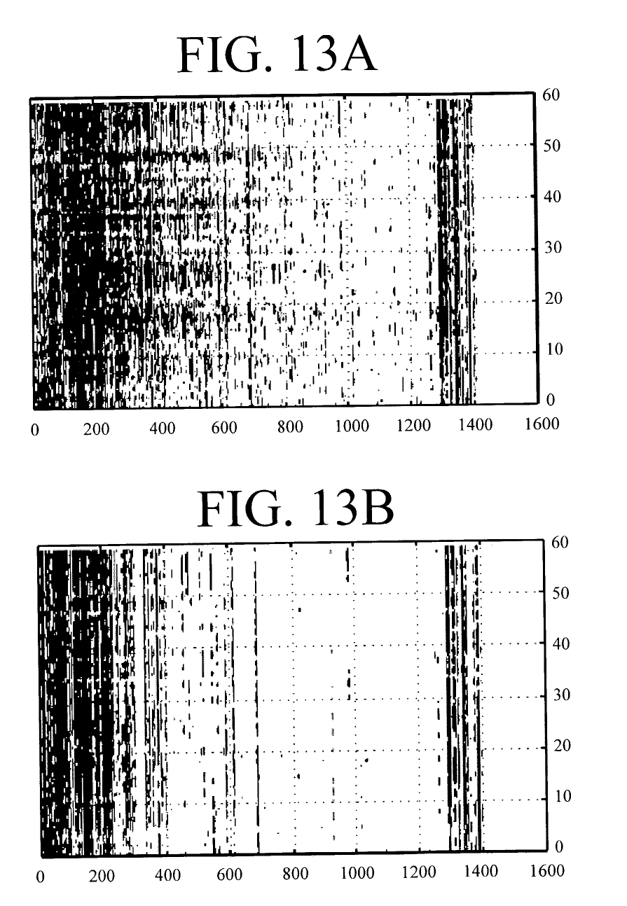

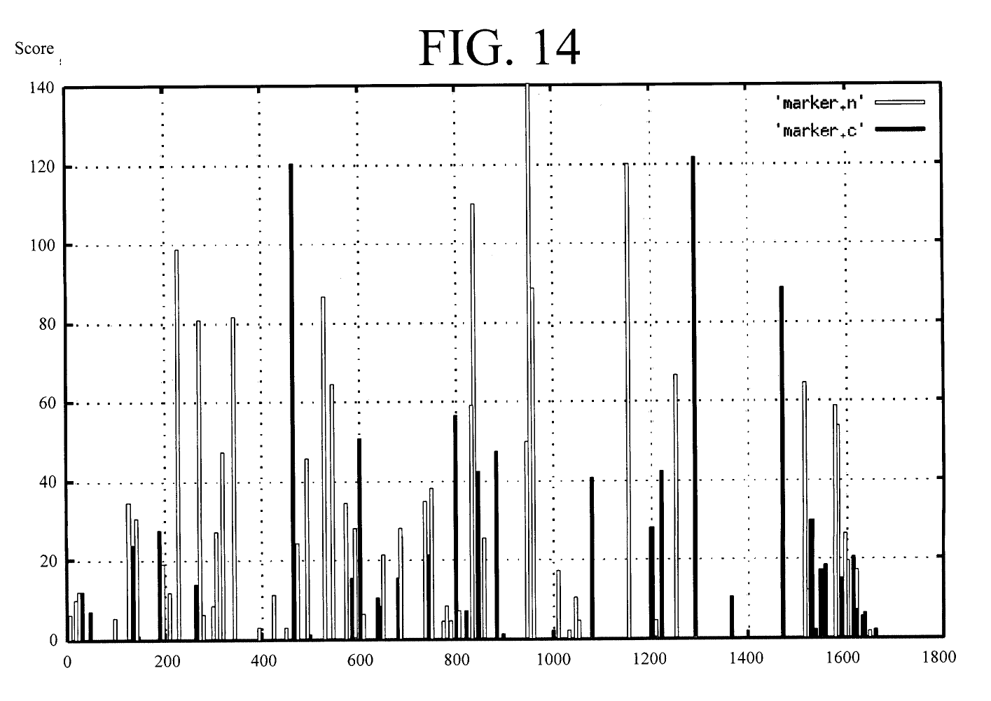

A similar analysis and evaluation was performed on a digitized images of stained 2D electrophoresis gels representing samples of patients with colon cancer, the data being obtained from Large Scale Biology Corporation in Germantown Md. The gel images were transformed into spot intensities, each spot intensity associated with an (x,y) coordinate. The intensities are depicted in FIG. 13A, where the y-axis corresponds to patients and the x-axis corresponds to the protein spot intensity. After being analyzed and evaluated by the computer implemented methods of the present invention, the processed data was graphed, as shown in FIG. 13B, with all noise and irrelevant peaks removed. FIG. 14 shows markers that indicate normal patients and markers that indicate diseased patients.

The methods of the present invention again clearly identified a large number of bio-markers.

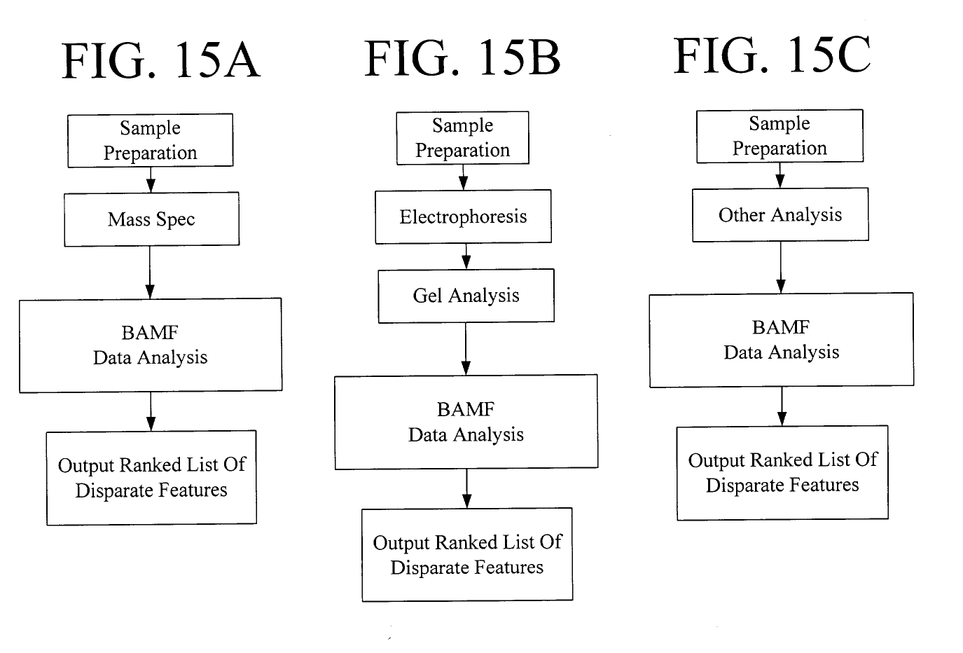

In accordance with the present invention, the BAMF data analysis methods may be used on a variety of types of data. As described above, mass spectra is analyzed and evaluated to identify a plurality of ovarian bio-markers, as depicted in FIG. 7. As shown in FIG. 15A, such data is obtained by first processing a sample from a patient, subjecting the sample to mass spectrometry analysis, enter the data from a plurality of such patients into a computer programmed to conduct the BAMF data analysis, and the resulting output will include identification of disparate features, which will provide the scientist with identification of bio-markers.

Similarly, colon cancer data from 2D electrophoresis gels is analyzed and evaluated in accordance with the present invention to identify colon cancer bio-markers, as depicted in FIG. 14. As shown in FIG. 15B, such data is obtained by first processing a sample from a patient, subjecting the sample to two dimensional electrophoresis, stain and scan the electrophoresis gel, enter data of a plurality of such gel images into a computer programmed to conduct the BAMF data analysis, and the resulting output will include identification of disparate features, which will provide the scientist with identification of bio-markers.

Similarly, other data may be analyzed and evaluated in accordance with the present invention to identify disease state bio-markers. As shown in FIG. 15C, such data is obtained by first processing a sample from a patient, subjecting the sample to other analysis, enter data into a computer programmed to conduct the BAMF data analysis, and the resulting output will include identification of disparate features, which will provide the scientist with identification of bio-markers.

The other data referred to in FIG. 15C, may be, for instance, image data such as images of microarrays or satellite images.

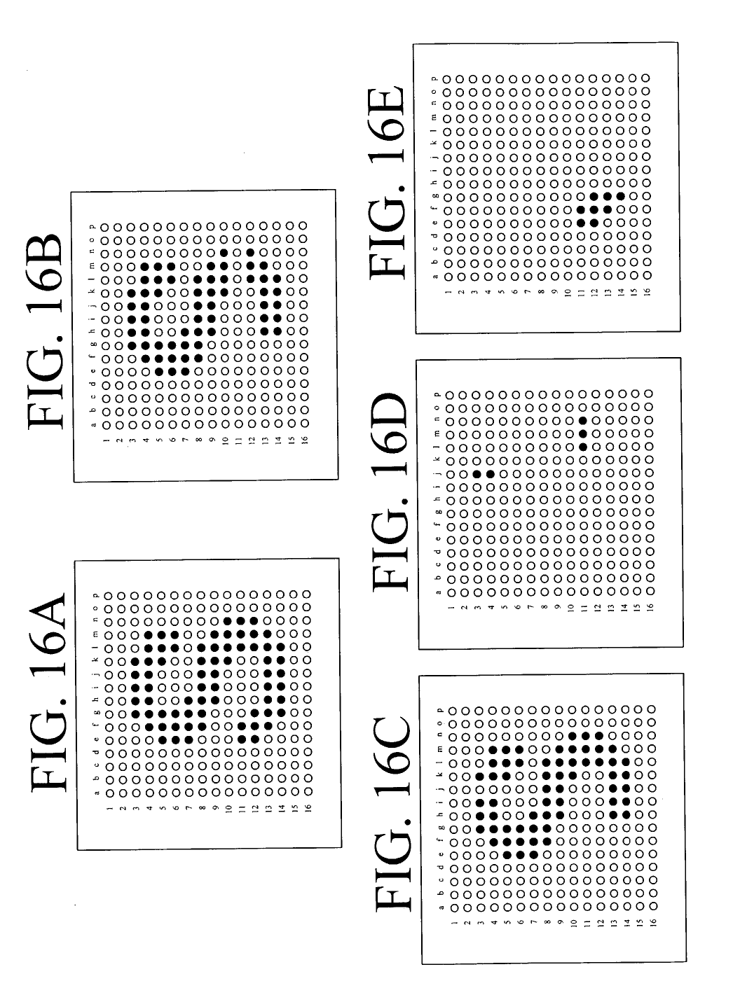

For example, FIG. 16A is an image of a microarray formed with a plurality of bio-reactive spots, each spot engineered to capture a specific bio-molecule, such as a protein, protein fragment, DNA fragment, RNA fragment, etc. FIG. 16A shows a microarray with captured bio-molecules from a healthy patient. FIGS. 16B and 16C show the same type of microarray having the same type of bio-reactive spots, but with captured bio-molecules from two diseased patients. The images of the microarrays in FIGS. 16A, 16B and 16C are inputted into the BAMF analysis computer of the present invention, whose steps are depicted in FIG. 15C. Bio-markers are identified and/or recognized by reference to specific spot locations. FIG. 16D shows false positive markers that occurred in one or the other of the patient microarrays depicted in FIGS. 16B and 16C, but not in both. FIG. 16E shows those spots that are indeed bio-markers, the spots deviating from the normal.

It should be understood that the example shown in FIGS. 16A through 16E is a simplified example. Preferably, a dozen or more healthy patient microarrays are included along with a dozen or more disorder state patient microarrays to provide a greater statistical certainty of the false positive markers and confirmed bio-markers.

Further, the analysis of microarray images need not be microarray platform specific. There are many configurations of microarrays, with more entering the market on a regular basis. The methods of the present invention are applicable to any configuration of microarray, so long as healthy samples are compared with samples from a group of patients with a specific disorder or disease. Further, the BAMF analysis and evaluation methods of the present invention, are useful in image analysis. Using a fixed image or fixed set of images, a comparison is performed on similar images where disparate or discriminating features are to be identified.

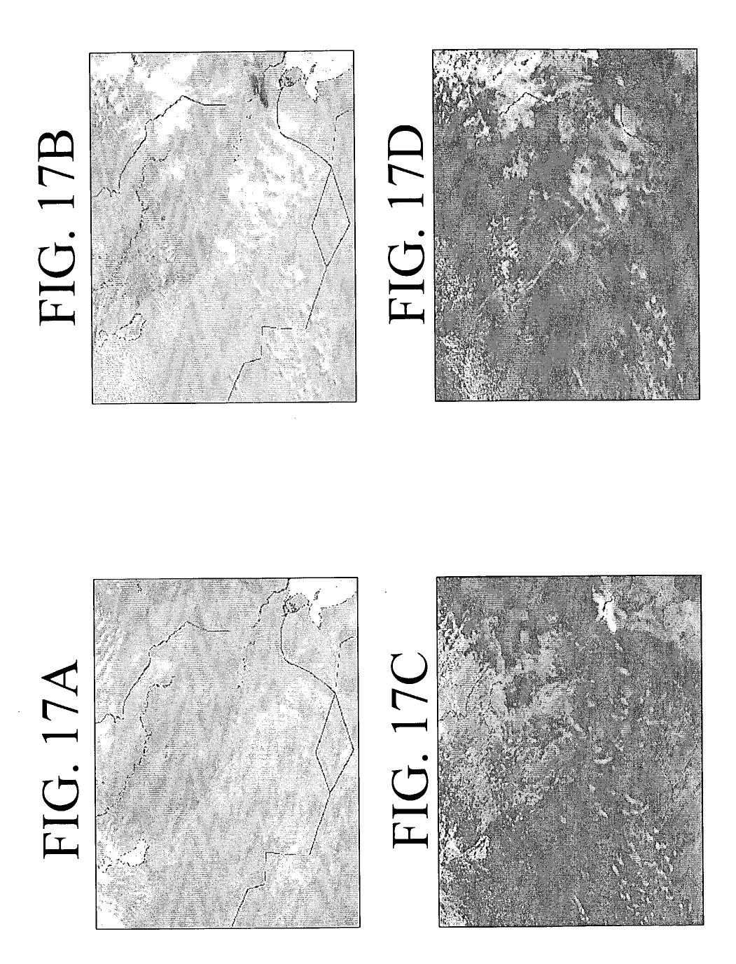

Images of any type may be analyzed using the BAMF methodology of the present invention, although in a preferred embodiment, the images are inputted in PGM format. For instance, a first satellite image of Iraq was taken early in 2003 before the war with that country, as shown in FIG. 17A. After the war started, another satellite photograph was taken, FIG. 17B, showing clouds and oil fires in southern Iraq. Both of the images FIG. 17A and 17B were inputted into a computer programmed to perform the BAMF analysis in accordance with an alternative embodiment of the present invention. A simple comparison of FIGS. 17A and 17B using BAMF yielded a clear identification of the oil fires, as shown in white in the lower right hand corner of enhanced FIG. 17C. Noise and unimportant features, such as clouds, are identifiable in enhanced FIG. 17D. Both FIGS. 17C and 17D were enhanced using the BAMF methodology, along with an additional feature of identification of light and dark areas (the oil fires being dark and the clouds being light).

A visual examination of FIGS. 17A, 17B, 17C and 17D highlights the advantages of the present invention when used in image comparison situations. A series of photographs taken of a specific location over time may be inputted into a computer programmed to perform the BAMF analysis to identify changes over time in the area covered by the photographs, in accordance with the present invention.

The methods and apparatus of the present invention, as described above, provide the researcher and scientist with tools to rapidly and accurately identify bio-markers where healthy patient data and diseased or disordered patient data is compared. Such data may be a collection of mass spectrometer spectra, 2-D electrophoresis gel images, and/or microarray images.

A computer system programmed to perform the methods of the present invention is trained to distinguish data for a specific disease state. New data is entered into the computer for confirmation of the condition of the corresponding patient to determine whether or not the patient has the specific disorder corresponding to the previously identified bio-marker(s). Such a computer system is trainable to distinguish a collection of mass spectrometer spectra, 2-D electrophoresis gel images, or microarray images, and is therefore ideally suited for a diagnostic application.

The method and apparatus of the present invention may also be used to compare two or more photographs of the same region, to identify disparate features. The present invention may be used to analyze satellite photographs to monitor construction or movements on the ground in a specific region of the world.

Acknowledgments

We are indebted to the Clinical Proteomics Program databank for making available the SELDI-MS data used in this study.

Appendix: Biomarker Model Builder

From the initial set of features computed by BAMF it is often desirable to select subsets of this initial set. We have chosen to implement a simple threshold/window based algorithm. Characteristics for which threshold/window values are used as a selection criteria are: a) m/z range, b) peak intensity, c) average peak separation (normal vs disease), d) predictive value positive/negative, e) sensitivity and specificity.

References

[1] S. Haykin, Neural Networks: A Comprehensive Foundation, Prentice-Hall, Inc. (1999), second edition, 508-512.

[2] Ukrainec, A. M., S. Haykin, A modular neural network for enhancement of cross-polar radar targets, Neural Networks 9, 143-168 (1996).

[3] Ukrainec, A. M., S. Haykin, Enhancement of radar images using mutual information based unsupervised neural networks, Canadian Conference on Electrical and Computer Engineering, pp. MA6.9.1-MA6.9.4, Toronto, Canada.

[4] Petricoin, E. F., et al, Use of proteomic patterns in serum to identify ovarian cancer, The Lancet 9, 572-577 (2002).

[5] SELDI MS data at the following website: clinicalproteomics (dot) steem (dot) com/Ovarian\%20Data\%20WCX2\%20XLS (dot) zip.

[6] Colon Cancer data set. University Of South Florida (USF) and Large Scale Biology Corporation, Germantown, Md.

[7] R. O. Duda, P. E. Hart, D. G. Stork, Pattern Classification, second edition, John Wiley \& Sons, Inc., 2001.

[8] H. Ritter, Self-organizing feature maps: Kohonen maps, in M. A. Arbib, ed., The Handbook of Brain Theory and Neural Networks, pp. 846-851, Bambridge, Mass.: MIT Press.

[9] S. Haykin, Neural Networks: A Comprehensive Foundation, Prentice-Hall, Inc. (1999), second edition.

What is claimed is:

1. A method for computer implemented identification of disparate features in at least two different images, comprising the steps of:
providing at least two images to a computer, the two images showing the generally the same subject matter, but with possible differences therebetween;
analyzing the two images using a radial basis function;
creating a new image by removing commonality between the two images;
depicting disparate features remaining in the image created in said creating step.

2. A method as set forth in claim 1, further comprising the steps of:
creating a first satellite image of a region;
creating a second satellite image of the region taken at a later time interval;
wherein the first and second satellite images are inputted into the computer in said providing step.

3. A method as set forth in claim 2, further comprising the step of:
creating a plurality of additional satellite images of the region, each additional satellite image being taken at a different time interval, wherein the plurality of satellite images are inputted into the computer along with the first and second images in said providing step.

4. A method as set forth in claim 1, further comprising the steps of:
creating a first image of a microarray that has been subjected to a sample from a healthy patient;
creating a second image of another microarray that has been subjected to a sample from a diseased patient;
wherein the first and second images are inputted into the computer in said providing step.

5. A method as set forth in claim 4, further comprising the step of:
creating a plurality of additional images of microarrays, each additional image being taken of a microarray subjected to samples from different patients, wherein the plurality of images are inputted into the computer along with the first and second images in said providing step.

6. A method as set forth in claim 1, further comprising the steps of:
creating a first image of mass spectra from a sample from a healthy patient;
creating a second image of mass spectra from a sample from a diseased patient;
wherein the first and second images are inputted into the computer in said providing step.

7. A method as set forth in claim 6, further comprising the step of:
creating a plurality of additional images of mass spectra, each additional image of mass spectra from a sample from different patients, healthy and diseased, wherein the plurality of additional images are inputted into the computer along with the first and second images in said providing step.

8. A method for automated computer identification of disorder markers from data:
compiling a data set that includes at least two related data groups;
categorizing the data set based upon differences in the at least two related data groups; and
subtracting commonality between the at least two related data groups thereby identifying differences between the at least two related data groups.

9. A method for automated computer identification of disease markers as set forth in claim 8 wherein after said compiling step but before said categorizing step the method further includes the following step:
performing quality control on the data set.

10. A method for automated computer identification of disease markers as set forth in claim 9 wherein said performing quality control step includes normalizing the data set.

11. A method for automated computer identification of disease markers as set forth in claim 9 wherein after said performing quality control step but before said categorizing step the method further includes the following step:
enhancing features of the data set.

12. A method for automated computer identification of disease markers as set forth in claim 8 wherein said compiling step includes compiling mass spectrometry spectra data.

13. A method for automated computer identification of disease markers as set forth in claim 8 wherein said compiling step includes compiling spot location data from scanned electrophoresis gels.

14. A method for automated computer identification of disease markers as set forth in claim 8 wherein said subtracting step includes subtracting spectral information from one of the at least two related data groups in the mass spectrometry spectra data.

15. A method for automated computer identification of disease markers as set forth in claim 8 wherein said categorizing step includes use of a neural network for discriminating features in the data set.

16. A method for automated computer identification of disease markers as set forth in claim 8 wherein said subtracting set includes the use of radial basis functions for performing statistical differencing.

17. A computer apparatus comprising:
means for inputting unknown data;
means for comparing unknown data with two previously analyzed and evaluated data sets having disparate features, said means for comparing determining whether or not the unknown data includes the previously identified disparate features;
outputting identification of disparate features in the unknown data.
